(19) United States
(12) Patent Application Publication
(10) Pub. No.: US 2012/0194544 A1
(43) Pub. Date: Aug. 2, 2012

(54) ELECTRONIC EQUIPMENT

(75) Inventor: Masahiro YOKOHATA, Osaka City (JP)

(73) Assignee: SANYO ELECTRIC CO., LTD., Moriguchi City (JP)

(21) Appl. No.: 13/362,498

(22) Filed: Jan. 31, 2012

(30) Foreign Application Priority Data
Jan. 31, 2011 (JP) 2011-018474
Dec. 22, 2011 (JP) 2011-281258

(51) Int. Cl. G06T 5/00

(52) U.S. Cl. 345/619

(57) ABSTRACT

Electronic equipment includes a display portion that displays a thumbnail image of an input image, a user interface that receives a modifying instruction operation for instructing to perform a modifying process, and an image processing portion that performs the modifying process on the input image or an image to be a base of the input image in accordance with the modifying instruction operation. When the thumbnail image is displayed on the display portion, it is visually indicated using the display portion whether or not the input image is an image obtained via the modifying process.

### CROSS-REFERENCE TO RELATED APPLICATIONS

This nonprovisional application claims priority under 35 U.S.C. §119(a) on Patent Application No. 2011-018474 filed in Japan on Jan. 31, 2011 and Patent Application No. 2011-281258 filed in Japan on Dec. 22, 2011, the entire contents of which are hereby incorporated by reference.

### BACKGROUND OF THE INVENTION

1. Field of the Invention

The present invention relates to electronic equipment such as an image pickup apparatus.

2. Description of Related Art

There are proposed various methods for changing a focused state (such as a depth of field) of a taken image by image processing after photographing the image by an image pickup apparatus. One type of such image processing is called a digital focus. Here, image processing for modifying an image, including the above-mentioned image processing, is referred to as a modifying process. In addition, an image that is not processed by the modifying process is referred to as an original image, and an image obtained by performing the modifying process on the original image is referred to as a modified image. FIG. 27 illustrates a relationship among the original image and a plurality of modified images.

It is possible to perform the modifying process repeatedly and sequentially on the original image. In other words, as illustrated in FIG. 27, a modifying process is performed on an original image 900 so as to obtain a modified image 901, and then another modifying process can be performed on the modified image 901 so as to generate a modified image 902 different from the modified image 901. Note that in the example of FIG. 27, it is supposed that the depth of field of the original image 900 is narrowed by the modifying process, and a blur degree of a subject image is expressed by thickness of contour of the subject.

On the other hand, electronic equipment handling many input images is usually equipped with a thumbnail display function. Each of the original image and the modified image is one type of the input image, and here, it is supposed that the electronic equipment is an image pickup apparatus. In a thumbnail display mode for realizing the thumbnail display function, generally as illustrated in FIG. 28, a plurality of thumbnail images (six thumbnail images in the example of FIG. 28) of a plurality of input images are arranged and displayed simultaneously on a display screen. The thumbnail image is usually a reduced image of the corresponding input image.

When the user desires to view or edit any one of the input images, the user selects the thumbnail image corresponding to the noted input image from the plurality of displayed thumbnail images using a user interface. After this selection, the user can perform a desired operation on the noted input image.

Here, the desired operation includes an instruction to perform the above-mentioned modifying process for modifying the noted input image, the user of the image pickup apparatus as electronic equipment can instruct to perform the modifying process (for example, image processing for changing the depth of field of the original image) on a taken original image. The user who uses this modifying process usually stores both the original image and the modified image in a recording medium. As a result, input images as the original images and input images as the modified images are recorded in a mixed manner in the recording medium of the image pickup apparatus. FIG. 29 illustrates an example of a thumbnail display screen when such a mix is occurred. In FIG. 29, images TM₉₀₀ and TM₉₀₁ are thumbnail images corresponding to the original image 900 and the modified image 901 of FIG. 27, respectively.

Note that there is a conventional method of displaying a ranking corresponding to a smile level of a person in the image together with the thumbnail images.

The user who views the display screen of FIG. 29 can select a thumbnail image corresponding to a desired input image among a plurality of thumbnail images including the thumbnail images TM₉₀₀ and TM₉₀₁. However, because a display size of the thumbnail image is not sufficiently large, and because the thumbnail images TM₉₀₀ and TM₉₀₁ are usually similar to each other, it may be difficult in many cases for the user to decide whether the noted thumbnail image is one corresponding to the original image or one corresponding to the modified image. If this decision can be made easily, the user can easily find out the desired input image (either one of the original image and the modified image). Note that the conventional method of displaying the above-mentioned ranking does not contribute to making the above-mentioned decision easier.

### SUMMARY OF THE INVENTION

Electronic equipment according to the present invention includes a display portion that displays a thumbnail image of an input image, a user interface that receives a modifying instruction operation for instructing to perform a modifying process, and an image processing portion that performs the modifying process on the input image or an image to be a base of the input image in accordance with the modifying instruction operation. When the thumbnail image is displayed on the display portion, it is visually indicated using the display portion whether or not the input image is an image obtained via the modifying process.

### BRIEF DESCRIPTION OF THE DRAWINGS

FIG. 1 is a schematic general block diagram of an image pickup apparatus according to a first embodiment of the present invention.

FIG. 2 is an internal block diagram of the image pickup portion of FIG. 1.

FIG. 3A is a diagram illustrating meaning of a subject distance, FIG. 3B is a diagram illustrating a noted image, and FIG. 3C is a diagram illustrating meaning of a depth of field.

FIG. 4 is a diagram illustrating a structure of an image file according to a first embodiment of the present invention.

FIG. 5 is a diagram illustrating a subject distance detecting portion disposed in the image pickup apparatus of FIG. 1.

FIG. 6 is a diagram illustrating a relationship among a plurality of input images, a plurality of thumbnail images, and a plurality of image files.

FIG. 7 illustrates a block diagram of a portion particularly related to a characteristic action of the first embodiment of the present invention.

FIG. 8 is a diagram illustrating a manner in which a modified image is stored in the image file.

FIG. 9 is a flowchart of an action of generating the modified image by the image pickup apparatus of FIG. 1.

FIG. 10 is a diagram illustrating a relationship among a plurality of input images, a plurality of thumbnail images, and a plurality of image files.

FIG. 11A is a diagram illustrating a manner in which a plurality of display regions are set on the display screen, and FIG. 11B is a diagram illustrating a manner in which a plurality of thumbnail images are displayed simultaneously on the display screen.

FIG. 12 is a flowchart illustrating an action of the image pickup apparatus of FIG. 1 in a thumbnail display mode.

FIG. 13 is a diagram illustrating a manner in which one thumbnail image is designated in the thumbnail display mode.

FIG. 14 is a diagram illustrating a timing relationship among a selection operation, a modifying process, and the like.

FIG. 15 is a diagram illustrating an input image, a modified image, and thumbnail images corresponding to the same.

FIGS. 16A and 16B are diagrams illustrating examples of an updated display screen in the thumbnail display mode.

FIGS. 17A and 17B are diagrams illustrating a manner in which two modified images are generated based on an original image.

FIG. 18 is a diagram illustrating meanings of a plurality of symbols.

FIGS. 19A to 19C are diagrams illustrating thumbnail images displayed on the display screen according to a display method example α₁.

FIGS. 20A to 20C are diagrams illustrating thumbnail images displayed on the display screen according to a display method example α₂.

FIGS. 21A to 21D are diagrams illustrating thumbnail images displayed on the display screen according to a display method example α₃.

FIGS. 22A to 22D are diagrams illustrating thumbnail images displayed on the display screen according to a display method example α₄.

FIGS. 23A to 23D are diagrams illustrating thumbnail images displayed on the display screen according to a display method example α₅.

FIGS. 24A to 24C are diagrams illustrating thumbnail images displayed on the display screen according to a display method example β₁.

FIG. 25 is a diagram illustrating a thumbnail image displayed on the display screen according to a display method example β₁.

FIGS. 26A to 26C are diagrams illustrating thumbnail images displayed on the display screen according to a display method example β₂.

FIG. 27 is a diagram illustrating a relationship between the original image and the modified image according to a conventional technique.

FIG. 28 is a diagram illustrating a display screen example in the thumbnail display mode according to a conventional technique.

FIG. 29 is a diagram illustrating a display screen example in the thumbnail display mode according to a conventional technique.

FIG. 30 illustrates a block diagram of a portion particularly related to a characteristic action according to a second embodiment of the present invention.

FIG. 31 is a diagram illustrating an input image supposed in the second embodiment of the present invention.

FIGS. 32A to 32D are diagrams illustrating the input images and the modified images according to the second embodiment of the present invention.

FIG. 33 is a diagram illustrating a structure of an image file according to the second embodiment of the present invention.

FIG. 34 is a diagram illustrating the input image, the thumbnail image corresponding to the same, and the image file according to the second embodiment of the present invention.

FIGS. 35A to 35C are diagrams illustrating a plurality of thumbnail images according to the second embodiment of the present invention.

FIGS. 36A to 36C are diagrams illustrating examples of the thumbnail images displayed on the display screen according to the second embodiment of the present invention.

FIGS. 37A to 37C are diagrams illustrating other examples of the thumbnail images displayed on the display screen according to the second embodiment of the present invention.

FIGS. 38A to 38C are diagrams illustrating still other examples of the thumbnail images displayed on the display screen according to the second embodiment of the present invention.

### DETAILED DESCRIPTION OF THE PREFERRED EMBODIMENTS

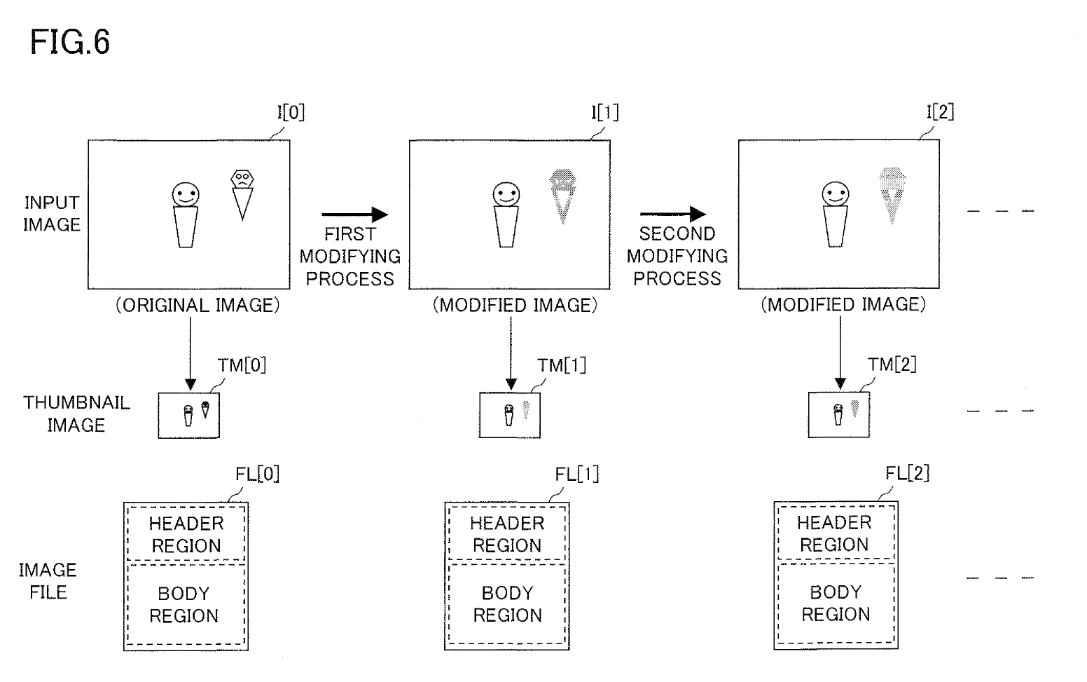

Hereinafter, examples of an embodiment of the present invention are described specifically with reference to the attached drawings. In the drawings to be referred to, the same part is denoted by the same numeral or symbol, and overlapping description of the same part is omitted as a rule. Note that in this specification, for simple description, a name of information, physical quantity, state quantity, a member, or the like corresponding to the numeral or symbol may be shortened or omitted by adding the numeral or symbol referring to the information, the physical quantity, the state quantity, the member, or the like. For instance, when an input image is denoted by symbol I[i] (see FIG. 6), the input image I[i] may be expressed shortly by image I[i] or simply by I[i].

### First Embodiment

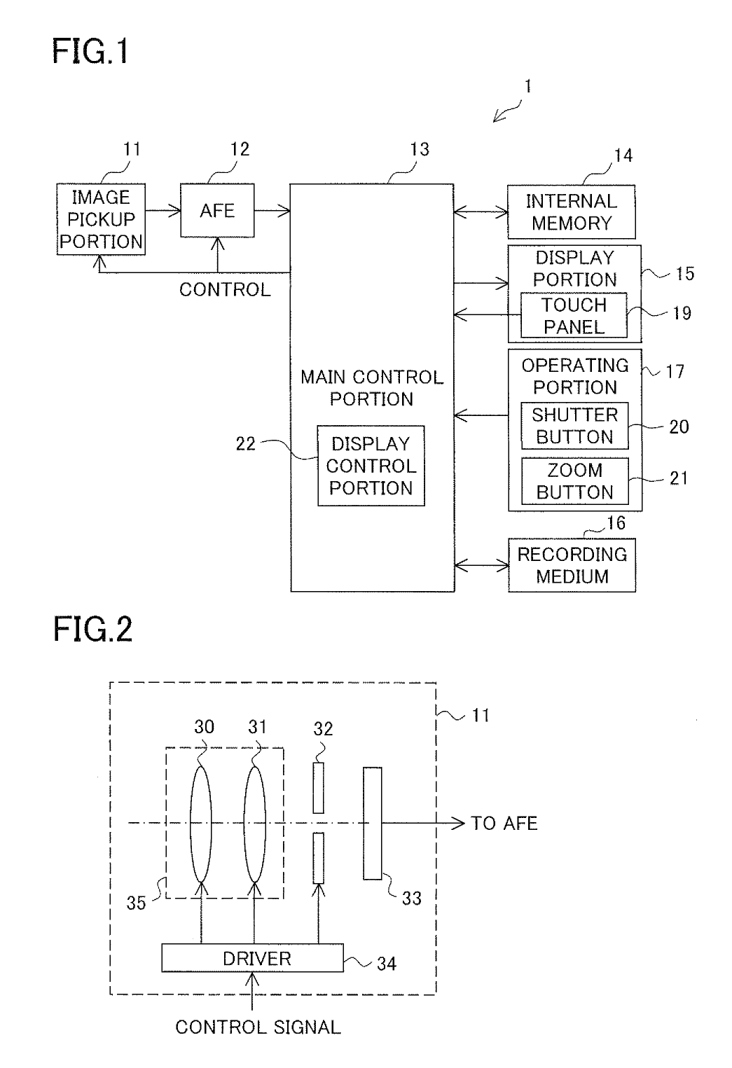

A first embodiment of the present invention is described. FIG. 1 is a schematic general block diagram of an image pickup apparatus 1 according to a first embodiment of the present invention. The image pickup apparatus 1 is a digital video camera that can take and record still images and moving images. However, the image pickup apparatus 1 may be a digital still camera that can take and record only still images. In addition, the image pickup apparatus 1 may be one that is incorporated in a mobile terminal such as a mobile phone.

The image pickup apparatus 1 includes an image pickup portion 11, an analog front end (AFE) 12, a main control portion 13, an internal memory 14, a display portion 15, a recording medium 16, and an operating portion 17. Note that the display portion 15 can be interpreted to be disposed in an external device (not shown) of the image pickup apparatus 1.

The image pickup portion 11 photographs a subject using an image sensor. FIG. 2 is an internal block diagram of the image pickup portion 11. The image pickup portion 11 includes an optical system 35, an aperture stop 32, an image sensor (solid-state image sensor) 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 for adjusting an angle of view of the image pickup portion 11 and a focus lens 31 for focusing. The zoom lens 30 and the focus lens 31 can move in an optical axis direction. Based on a control signal from the main control portion 13, positions of the zoom lens 30 and the focus lens 31 in the optical system 35 and an opening degree of the aperture stop 32 (namely a stop value) are controlled.

The image sensor 33 is constituted of a plurality of light receiving pixels arranged in horizontal and vertical directions. The light receiving pixels of the image sensor 33 perform photoelectric conversion of an optical image of the subject entering through the optical system 35 and the aperture stop 32, so as to deliver an electric signal obtained by the photoelectric conversion to the analog front end (AFE) 12.

The AFE 12 amplifies an analog signal output from the image pickup portion 11 (image sensor 33) and converts the amplified analog signal into a digital signal so as to deliver the digital signal to the main control portion 13. An amplification degree of the signal amplification in the AFE 12 is controlled by the main control portion 13. The main control portion 13 performs necessary image processing on the image expressed by the output signal of the AFE 12 and generates an image signal (video signal) of the image after the image processing. The main control portion 13 includes a display control portion 22 that controls display content of the display portion 15, and performs control necessary for the display on the display portion 15.

The internal memory 14 is constituted of a synchronous dynamic random access memory (SDRAM) or the like and temporarily stores various data generated in the image pickup apparatus 1.

The display portion 15 is a display device having a display screen such as a liquid crystal display panel so as to display taken images, images recorded in the recording medium 16, or the like, under control of the main control portion 13. In this specification, when referred to simply as a display or a display screen, it means the display or the display screen of the display portion 15. The display portion 15 is equipped with a touch panel 19, so that a user can issue a specific instruction to the image pickup apparatus 1 by touching the display screen of the display portion 15 with a touching member (such as a finger or a touch pen). Note that it is possible to omit the touch panel 19.

The recording medium 16 is a nonvolatile memory such as a card-like semiconductor memory or a magnetic disk, which records an image signal of the taken image or the like under control of the main control portion 13. The operating portion 17 includes a shutter button 20 for receiving an instruction to take a still image, a zoom button 21 for receiving an instruction to change a zoom magnification, and the like, so as to receive various operations from the outside. An operation content of the operating portion 17 is sent to the main control portion 13. The operating portion 17 and the touch panel 19 can be referred to as a user interface for accepting a user's arbitrary instruction or operation. The shutter button 20 and the zoom button 21 may be buttons on the touch panel 19.

Action modes of the image pickup apparatus 1 includes a photographing mode in which images (still images or moving images) can be taken and recorded, and a reproducing mode in which images (still images or moving images) recorded in the recording medium 16 can be reproduced and displayed on the display portion 15. Transition between the modes is performed in accordance with an operation to the operating portion 17.

In the photographing mode, a subject is photographed periodically at a predetermined frame period so that taken images of the subject are sequentially obtained. An image signal (video signal) expressing an image is also referred to as image data. The image signal contains a luminance signal and a color difference signal, for example. Image data of a certain pixel may be also referred to as a pixel signal. A size of a certain image or a size of an image region may be also referred to as an image size. An image size of a noted image or a noted image region can be expressed by the number of pixels forming the noted image or the number of pixels belonging to the noted image region. Note that in this specification, image data of a certain image may be referred to simply as an image. Therefore, for example, generation, recording, modifying, deforming, editing, or storing of an input image means generation, recording, modifying, deforming, editing, or storing of image data of the input image.

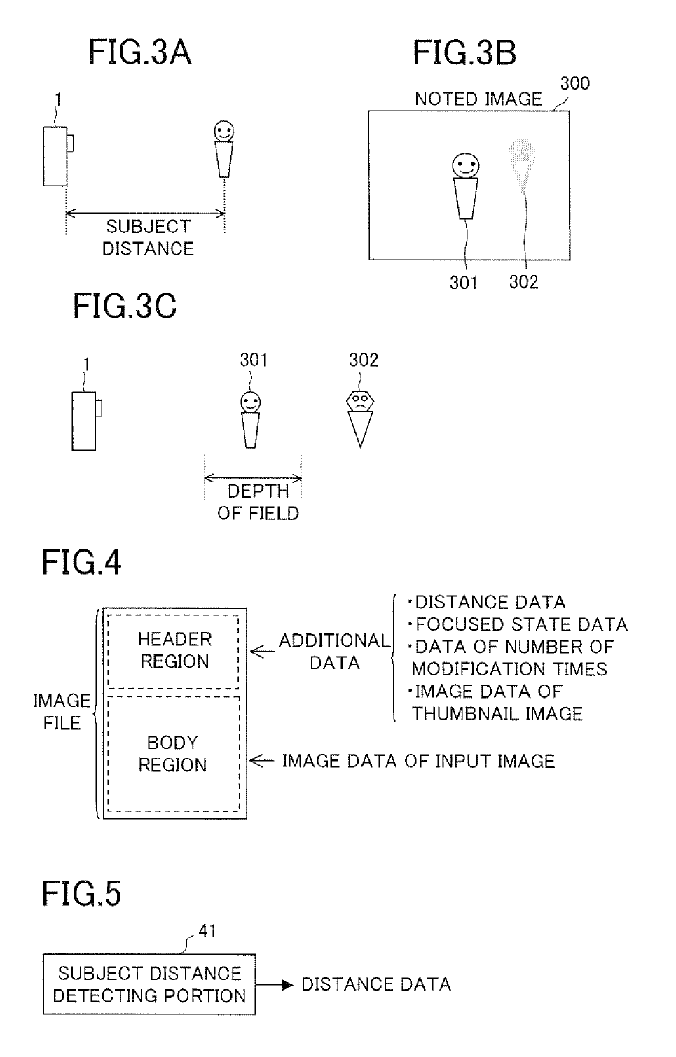

As illustrated in FIG. 3A, a distance in the real space between an arbitrary subject and an image pickup apparatus 1 (more specifically, the image sensor 33) is referred to as a subject distance. When a noted image 300 illustrated in FIG. 3B is photographed, a subject 301 having a subject distance within the depth of field of the image pickup portion 11 is focused on the noted image 300, and a subject 302 having a subject distance outside the depth of field of the image pickup portion 11 is not focused on the noted image 300 (see FIG. 3C). In FIG. 3B, a blur degree of a subject image is expressed by thickness of contour of the subject (the same is true in FIG. 6 and the like referred to later).

FIG. 4 illustrates a structure of an image file storing image data of an input image. An image based on an output signal of the image pickup portion 11, namely an image obtained by photography using the image pickup apparatus 1 is one type of the input image. The input image can be also referred to as a target image or a record image. One or more image files can be stored in the recording medium 16. In the image file, there are disposed a body region for storing image data of the input image and a header region for storing additional data corresponding to the input image. The additional data contains various data concerning the input image, which include distance data, focused state data, data of number of modification times, and image data of a thumbnail image.

The distance data is generated by a subject distance detecting portion 41 (see FIG. 5) equipped to the main control portion 13 or the like. The subject distance detecting portion 41 detects a subject distance of a subject at each pixel of the input image and generates distance data expressing a result of the detection (a detected value of the subject distance of the subject at each pixel of the input image). As a method of detecting the subject distance, an arbitrary method including a known method can be used. For instance, a stereo camera or a range sensor may be used for detecting the subject distance, or the subject distance may be determined by an estimation process using edge information of the input image.

The focused state data is data specifying a depth of field of the input image, and for example, the focused state data specifies a shortest distance, a longest distance, and a center distance among distances within the depth of field of the input image. A length between the shortest distance and the longest distance within the depth of field is usually called a magnitude of the depth of field. Values of the shortest distance, the center distance, and the longest distance may be given as the focused state data. Alternatively, data for deriving the shortest distance, the center distance, and the longest distance, such as a focal length, a stop value, and the like of the image pickup portion 11 when the input image is taken, may be given as the focused state data.

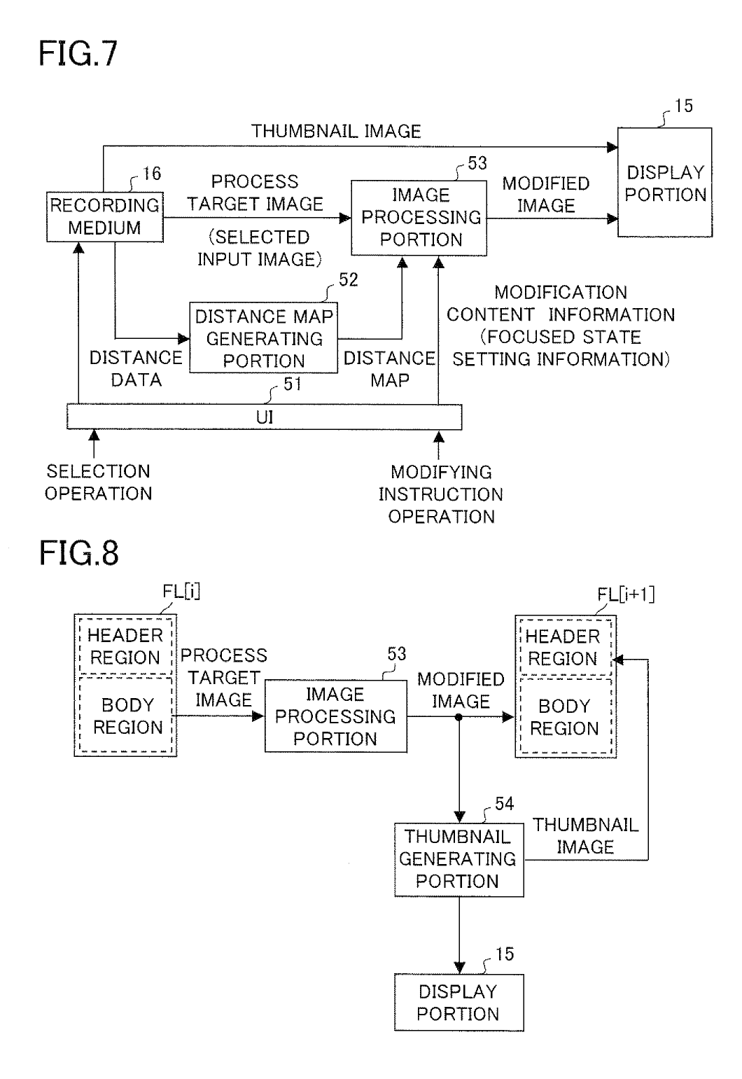

The data of number of modification times indicates the number of times of performing the modifying process for obtaining the input image (a specific example of the modifying process will be described later). As illustrated in FIG. 6, the input image on which the modifying process has not been performed yet is particularly referred to as an original image, and the input image as the original image is denoted by symbol I[0]. In addition, the input image obtained by performing the modifying process i times on the input image I[0] is denoted by symbol I[i] (i denotes an integer). In other words, if the modifying process is performed one time on the input image I[i], the input image I[i] is modified to the input image I[i+1]. Then, the number of times of performing the modifying process for obtaining the input image I[i] is i. Therefore, the data of number of modification times in the image file storing image data of the input image I[i] indicates a value of a variable i. Note that when the variable i is a natural number (namely, when i>0 holds), the input image I[i] is a modified image that will be described later (see FIG. 7). Therefore, the input image I[i] when the variable i is a natural number is also referred to as a modified image.

The thumbnail image is an image obtained by reducing resolution of the input image (namely, an image obtained by reducing an image size of the input image). Therefore, a resolution and an image size of the thumbnail image are smaller than a resolution and an image size of the input image. Reduction of the resolution or the image size is realized by a known resolution conversion. As illustrated in FIG. 6, the thumbnail image corresponding to the input image I[i] is denoted by TM[i]. Simply, for example, the thumbnail image TM[i] can be generated by thinning pixels of the input image I[i]. In addition, the image file storing image data of the input image I[i] is denoted by symbol FL[i] (see FIG. 6). The image file FL[i] also stores image data of the thumbnail image TM[i].

FIG. 7 illustrates a block diagram of a portion particularly related to a characteristic action of this embodiment. A user interface 51 (hereinafter referred to as UI 51) includes the operating portion 17 and the touch panel 19 (see FIG. 1). A distance map generating portion 52 and an image processing portion 53 can be disposed in the main control portion 13, for example.

The UI 51 accepts user's various operations including a selection operation for selecting a process target image and a modifying instruction operation for instructing to perform the modifying process on the process target image. The input images recorded in the recording medium 16 are candidates of the process target image, and the user can select one of a plurality of input images recorded in the recording medium 16 as the process target image by the selection operation. The image data of the input image selected by the selection operation is sent as image data of the process target image to the image processing portion 53.

The distance map generating portion 52 reads distance data from the header region of the image file storing image data of the input image as the process target image, and generates a distance map based on the read distance data. The distance map is a range image (distance image) in which each pixel value thereof has a detected value of the subject distance. The distance map specifies a subject distance of a subject at each pixel of the input image as the process target image. Note that the distance data itself may be the distance map, and in this case the distance map generating portion 52 is not necessary. The distance data as well as the distance map is one type of subject distance information.

The modifying instruction operation is an operation for instructing also content of the modifying process, and modification content information indicating the content of the modifying process instructed by the modifying instruction operation is sent to the image processing portion 53. The image processing portion 53 perfoiuirs the modifying process according to the modification content information on the input image as the process target image so as to generate the modified image. In other words, the modified image is the process target image after the modifying process.

Here, mainly it is supposed that the modification content information is focused state setting information. The focused state setting information is information designating a focused state of the modified image. The image processing portion 53 can adjust a focused state of the process target image by the modifying process based on the distance map, and can output the process target image after the focused state adjustment as the modified image. The modifying process for adjusting the focused state of the process target image is an image processing J based on the distance map, and the focused state adjustment in the image processing J includes adjustment of the depth of field. Note that the adjustment of the focused state or the depth of field causes a change of the focused state or the depth of field, so the image processing J can be said to be image processing for changing the focused state of the process target image.

For instance, in the modifying instruction operation, the user can designate a desired value CN_{DEP}* of a center distance CN_{DEP} in the depth of field of the modified image and a desired value M_{DEP}* of a magnitude of the depth of field M_{DEP} of the modified image. In this case, the desired values CN_{DEP}* and M_{DEP}* (in other words, the target values CN_{DEP}* and M_{DEP}*) are included in the focused state setting information. Then, in accordance with the focused state setting information, the image processing portion 53 performs the image processing J on the process target image based on the distance map so that the center distance CN_{DEP} and the magnitude M_{DEP} in the depth of field of the modified image respectively become those corresponding to CN_{DEP}* and M_{DEP}* (ideally, so that the center distance CN_{DEP} and the magnitude M_{DEP} of the modified image are agreed with CN_{DEP}* and M_{DEP}*, respectively).

The image processing J may be image processing that can arbitrarily adjust a focused state of the process target image. One type of the image processing J is also called digital focus, and there are proposed various image processing methods as the image processing method for realizing the digital focus. It is possible to use a known method that can arbitrarily adjust a focused state of the process target image based on the distance map (for example, a method described in JP-A-2010-81002, WO/06/039486 pamphlet, JP-A-2009-224982, JP-A-2010-252293, or JP-A-2010-81050) as a method of the image processing J.

The modified image or the thumbnail image read out from the recording medium 16 is displayed on the display portion 15. In addition, a modified image obtained by performing the modifying process on an input image can be newly recorded as image data of another input image in the recording medium 16.

FIG. 8 illustrates a conceptual diagram of this recording. A thumbnail generating portion 54 illustrated in FIG. 8 can be disposed in the display control portion 22 of FIG. 1, for example. Here, it is supposed that the input image I[i] stored in the image file FL[i] is supplied as the process target image to the image processing portion 53 (see FIG. 6, too). In this case, the image processing portion 53 generates the modified image obtained by performing the modifying process one time on the input image I[i] as the input image I[i+1]. The image data of the generated input image I[i+1] is stored in the image file FL[i+1], which is recorded in the recording medium 16. In addition, the thumbnail generating portion 54 generates a thumbnail image TM[i+1] from the input image I[i+1] as the modified image. The image data of the generated thumbnail image TM[i+1] is also stored in the image file FL[i±1], which is recorded in the recording medium 16. When the image file FL[i+1] storing image data of the input image I[i+1] and the thumbnail image TM[i+1] is recorded in the recording medium 16, the distance data, the focused state data, and the data of number of modification times corresponding to the input image I[i+1] are also stored in the image file FL[i+1]. The distance data corresponding to the input image I[i+1] is the same as the distance data stored in the image file FL[i]. The focused state data corresponding to the input image I[i+1] is determined according to the focused state setting information. The data of number of modification times corresponding to the input image I[i+1] is larger than the data of number of modification times stored in the image file FL[i] by one. Note that the thumbnail generating portion 54 can generate a thumbnail image TM[0] from the input image I[0] that is not a modified image, and can also generate a thumbnail image to be displayed on the display portion 15.

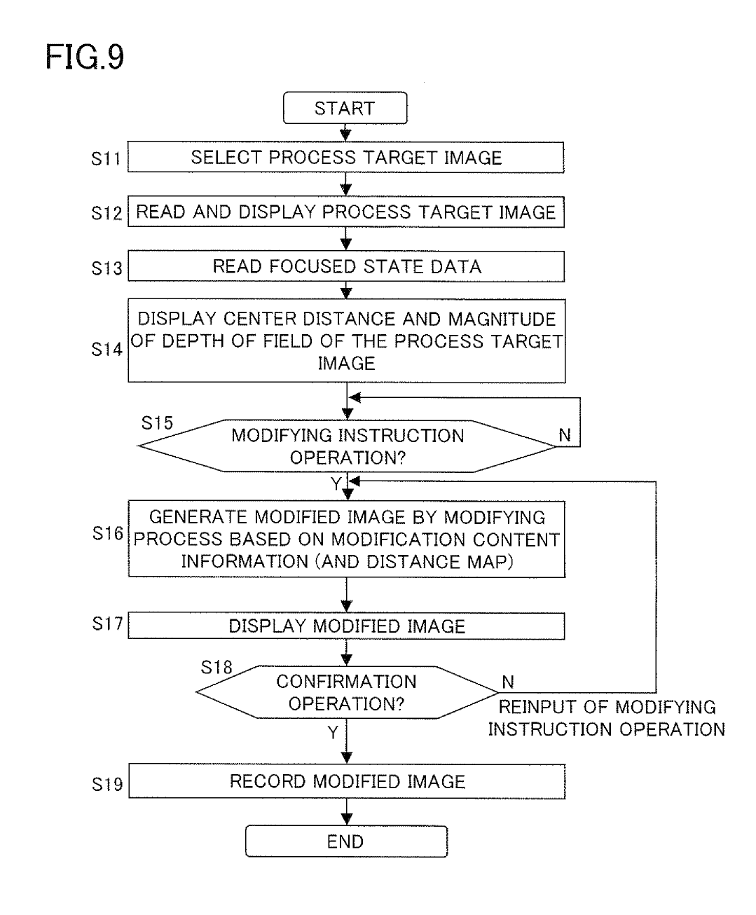

FIG. 9 illustrates a flowchart of an action generating a modified image. First, in Step S11, the process target image is selected in accordance with a selection operation. In the next Step S12, the image data of the process target image is sent from the recording medium 16 to the image processing portion 53, and the process target image is displayed on the display portion 15. Further in Step S13, the focused state data corresponding to the process target image is read out from the recording medium 16. In Step S14, the main control portion 13 determines a center distance and a magnitude of the depth of field of the process target image from the focused state data corresponding to the process target image. The determined values of the center distance (for example, 3 meters) and the magnitude of the depth of field (for example, 5 meters) are displayed on the display portion 15. After that, in Step S15, an input of the modifying instruction operation to the UI 51 is waited.

When the modifying instruction operation is performed, in Step S16, the image processing portion 53 performs the modifying process on the process target image in accordance with the modification content information based on the modifying instruction operation so as to generate the modified image. If the modification content information is the focused state setting information, the image processing J using a distance map of the process target image is performed on the process target image so as to generate the modified image. In an arbitrary timing after selection of the process target image (for example, just after the process of Step S11), the distance map of the process target image can be generated. In the next Step S17, the modified image generated in Step S16 is displayed on the display portion 15, and while performing this display, user's input of confirmation operation is waited in Step S18. If the user is satisfied with the modified image generated in Step S16, the user can perform the confirmation operation to the UI 51. Otherwise, the user can perform the modifying instruction operation again to the UI 51. If the modifying instruction operation is performed again in Step S18, the process goes back to Step S16 so that the process from Step S16 is performed repeatedly. In other words, in accordance with the modification content information based on the repeated modifying instruction operation, the modifying process is performed on the process target image so that the modified image is newly generated, and the newly generated modified image is displayed (Steps S16 and S17).

When the confirmation operation is performed in Step S18, the latest modified image generated in Step S16 is recorded in the recording medium 16 in Step S19. In this case, the thumbnail image based on the modified image recorded in the recording medium 16 is also recorded in the recording medium 16. If the process target image selected in Step S11 is the input image I[i], the modified image that is record in the recording medium 16 by performing the series of processes from Step S12 to Step S19 is the input image I[i+1]. In addition, when the image data of the input image I[i+1] is record in the recording medium 16 in Step S19, the image data of the input image I[i] may be deleted from the recording medium 16 in response to a user's instruction. In other words, the image before the modifying process may be overwritten by the image after the modifying process.

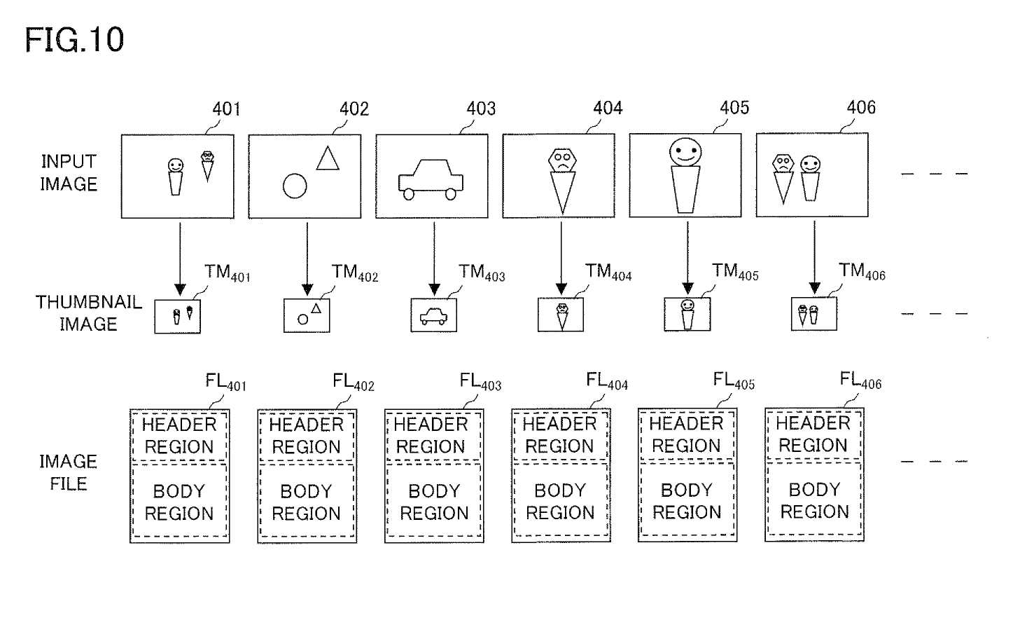

As one type of the reproducing mode, there is a thumbnail display mode, and the image pickup apparatus 1 can perform a specific display in the thumbnail display mode. In the first embodiment, hereinafter, unless otherwise noted, an action of the image pickup apparatus 1 in the thumbnail display mode is described. In addition, it is supposed that image data of a plurality of input images including the input images 401 to 406 illustrated in FIG. 10 are recorded in the recording medium 16. The thumbnail images corresponding to the input images 401 to 406 are denoted by symbols TM₄₀₁ to TM₄₀₆, respectively, and image files storing image data of the input images 401 to 406 are denoted by symbols FL₄₀₁ to FL₄₀₆, respectively. The image files FL₄₀₁ to FL₄₀₆ also store image data of the thumbnail images TM₄₀₁ to TM₄₀₆, respectively.

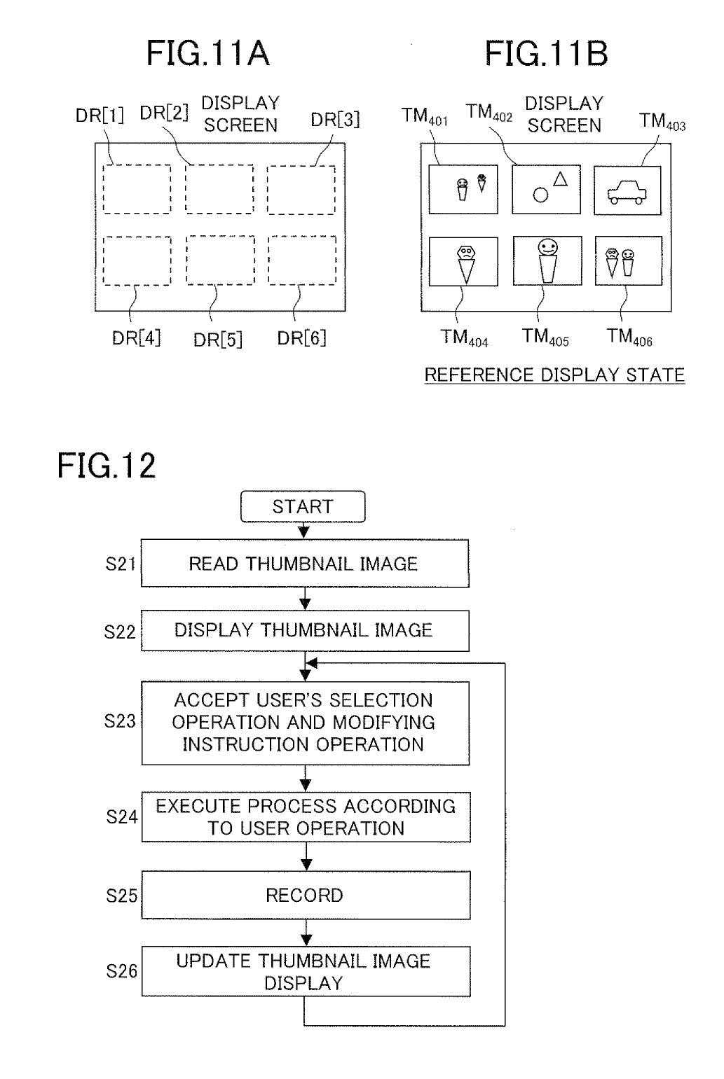

In the thumbnail display mode, a plurality of thumbnail images are simultaneously displayed on the display portion 15. For instance, a plurality of thumbnail images are displayed to be arranged in the horizontal and vertical directions on the display screen. In this embodiment, a state of the display screen illustrated in FIGS. 11A and 11B is considered to be a reference, and this display screen state is referred to as a reference display state. In the reference display state, six different display regions DR[1] to DR[6] are disposed on the display screen, and the thumbnail images TM₄₀₁ to TM₄₀₆ are displayed in the display regions DR[1] to DR[6], respectively, so that simultaneous display of the thumbnail images TM₄₀₁ to TM₄₀₆ is realized. However, in the thumbnail display mode, the number of thumbnail images displayed simultaneously may be other than six. In addition, in the thumbnail display mode, it is possible to display only one thumbnail image.

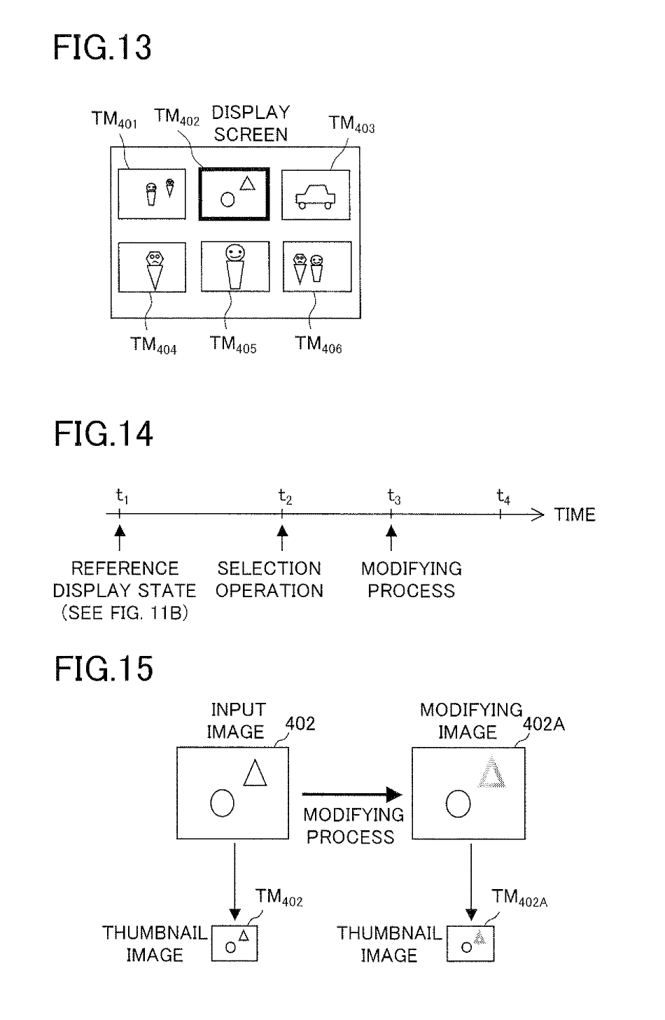

FIG. 12 illustrates a flowchart of an action in the thumbnail display mode. In the thumbnail display mode, one or more thumbnail images are read out from the recording medium 16 and are displayed on the display portion 15 in Steps S21 and S22, and the process of Steps S23 to S26 can be repeated. In Step S23, user's selection operation and modifying instruction operation are accepted. The user can designate any one of the thumbnail images on the display screen and can select an input image corresponding to the designated thumbnail image as the process target image. For instance, in the reference display state of FIG. 11B, the user can designate a thumbnail image TM₄₀₂ on the display screen via the UI 51 so as to select the input image 402 corresponding to the thumbnail image TM₄₀₂ as the process target image. FIG. 13 illustrates a display screen example when the thumbnail image TM₄₀₂ is designated. In Step S24, the modifying process according to the modifying instruction operation is performed on the process target image selected by the selection operation so that the modified image is generated. In Step S25, the modified image and the thumbnail image based on the modified image are recorded in the recording medium 16. The process of Steps S23 to S25 corresponds to the process of Steps S11 to S19 of FIG. 9.

After the process of Steps S23 to S25, if the thumbnail display mode is maintained, the thumbnail image display can be updated in Step S26, and after this update the process can go back to Step S23. In Step S26, display content of the display portion 15 is changed so that the thumbnail image based on the modified image generated in Step S24 is displayed on the display portion 15, for example.

A more specific display update method in Step S26 is exemplified. As illustrated in FIG. 14, it is supposed that a display state at time point t₁ is a reference display state (see FIG. 11B), and that the thumbnail image TM₄₀₂ is designated by the selection operation at time point t₂ so that the input image 402 is selected as the process target image, and that the modifying process is performed one time on the input image 402 at time point t₃ so that an image 402A of FIG. 15 is obtained as a modified image of the input image 402 (hereinafter, this supposed situation is referred to as a situation ST1). The time point tᵢ₊₁ is time point after the time point t. In addition, a thumbnail image generated by supplying the image 402A to the thumbnail generating portion 54 is expressed by symbol TM_{402A} (see FIG. 15). In the example of FIG. 15, it is supposed that the image processing J that makes the depth of field shallow has been performed as the modifying process on the input image 402.

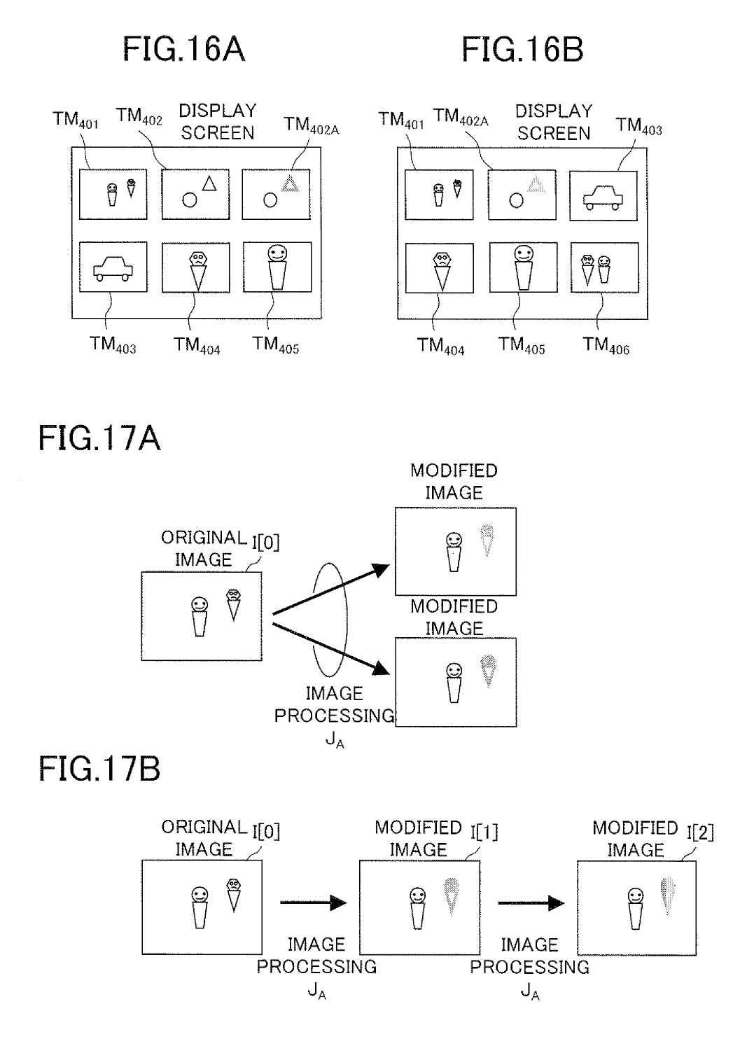

Under the situation ST₁, as illustrated in FIG. 16A, it is preferred to display the thumbnail images TM₄₀₁, TM₄₀₂, TM_{402A}, TM₄₀₃, TM₄₀₄, and TM₄₀₅ on the display screen simultaneously at time point t₄. In this case, it is preferred to determine display positions of the thumbnail images TM₄₀₂ and TM_{402A} so that the thumbnail images TM₄₀₂ and TM_{402A} are displayed adjacent to each other on the display screen. Alternatively, under the situation ST₁, as illustrated in FIG. 16B, it is possible to display the thumbnail images TM₄₀₁, TM_{402A}, TM₄₀₃, TM₄₀₄, TM₄₀₅, and TM₄₀₆ on the display screen simultaneously at time point t₄. The display illustrated in FIG. 16A can be applied to the case where an image file FL₄₀₂ storing the input image 402 is still stored in the recording medium 16 after the modifying process at the time point t₃. The display illustrated in FIG. 16B can be applied mainly to the case where the image file FL₄₀₂ is deleted from the recording medium 16 after the modifying process at the time point t₃.

The user who uses the modifying process such as the image processing J usually stores both the original image and the modified image in the recording medium 16. Therefore, after the modified image 402A is generated, the display is performed as illustrated in FIG. 16A. Viewing the display screen of FIG. 16A, the user can selects a thumbnail image corresponding to a desired input image among the plurality of thumbnail images including the thumbnail images TM₄₀₂ and TM_{402A}. However, because a display size of the thumbnail image is not sufficiently large, it may be difficult in many cases for the user to decide whether the noted thumbnail image is one corresponding to the original image or one corresponding to the modified image. If this decision can be made easily, it is useful for the user.

In addition, depending on a type of the modifying process, when the modifying process is performed, a part of information of the original image is lost in the modified image so that the modifying process may cause deterioration of image quality. For instance, it is supposed that image processing J_{A} for blurring background is adopted as the image processing 3, and that the image processing J_{A} is performed on the original image I[0] a plurality of times so as to obtain modified images I[1], I[2], and so on. Then, every time when the image processing J_{A} is performed, information of the original image I[0] is lost on the modified image.

If the user want to get two modified images having different blurring degrees of background, as illustrated in FIG. 17A, the image processing J_{A} is performed on the original image I[0] two times with different blurring degrees of background individually so as to obtain two modified images. On the other hand, there is another method as illustrated in FIG. 17B, in which the image processing J_{A} is performed on the original image I[0] one time to obtain a modified image I[1], and the image processing J_{A} is performed again on the modified image I[1] to generate a modified image I[2]. In the modified image I[2], because the image processing J_{A} is performed two times on the original image I[0] in a superimposing manner, loss of information of the original image or deterioration of image quality is increased.

On the other hand, as described above with reference to FIG. 13, the user can select a desired input image as the process target image by designating any one of thumbnail images on the display screen. In this case, if it is difficult to decide whether the noted thumbnail image is one corresponding to the original image or one corresponding to the modified image, even though the user wants to get two modified images by the method as illustrated in FIG. 17A, the user may select the modified image I[1] in error as the process target image, so that two modified images are unintentionally obtained in the method illustrated in FIG. 17B. On the contrary, even though the user want to get two modified images in the method illustrated in FIG. 17B, the user may select in error so that two modified images are obtained in the method illustrated in FIG. 17A. It is preferred to avoid occurrence of such situations.

The image pickup apparatus 1 has a special display function that also contributes to suppression of occurrence of such situations. When this special display function is used for displaying the thumbnail image TM₄₀₁ on the display portion 15, it is visually displayed whether or not the input image 401 corresponding to the thumbnail image TM₄₀₁ is an image obtained via the modifying process, using the display portion 15. The same is true for the thumbnail images TM₄₀₂ to TM₄₀₆.

In this way, the user can easily discriminate visually whether or not each of the displayed thumbnail images is a thumbnail image corresponding to the original image. As a result, it becomes easy to select a desired input image, and occurrence of the above-mentioned undesired situation can be avoided.

In addition, information loss or deterioration of image quality due to the modifying process is accumulated every time when the modifying process is performed. Therefore, it is useful to enable the user to recognize the number of times of performing the modifying process for obtaining the input image corresponding to the noted thumbnail image, by the thumbnail display. With this recognition, the user can grasp a degree of information loss or deterioration of image quality of the input image corresponding to each of the thumbnail images. Then, the user can select an appropriate input image as the process target image based on consideration of the degree of deterioration of image quality of each input image, for example. The special display function provides such usefulness, too. In other words, the special display function enables the user to recognize the number of times of performing the modifying process for obtaining the input image corresponding to each of the thumbnail images.

The special display function is applied to each of the thumbnail images TM₄₀₁ to TM₄₀₆, and the method of applying the special display function to the thumbnail images TM₄₀₂ to TM₄₀₆ is the same as the method of applying the same to the thumbnail image TM₄₀₁. Therefore, in the following description, there is described display content when the special display function is applied to the display of the thumbnail image TM₄₀₁, and descriptions of display contents when the special display function is applied to the thumbnail images TM₄₀₂ to TM₄₀₆ are omitted.

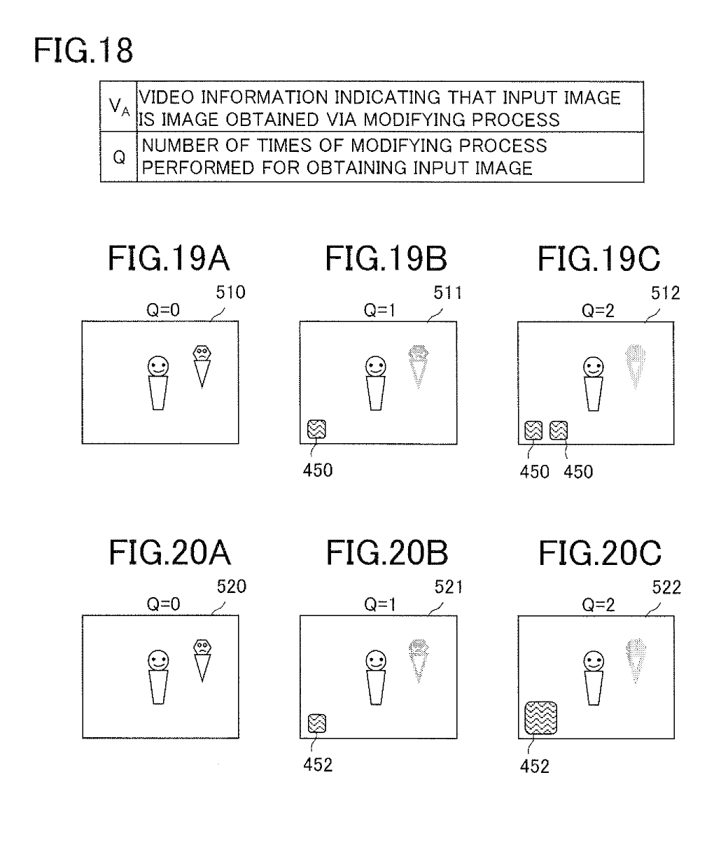

The method for realizing the above-mentioned special display function is roughly divided into a display method α and a display method β. Note that definitions of some symbols related to the display methods α and β are shown in FIG. 18.

The display method α is described below. In the display method α, when the thumbnail image TM₄₀₁ is displayed, if the input image 401 is an image obtained via the modifying process, video information V_{A} indicating that the input image 401 is an image obtained via the modifying process is also displayed (for example, see an icon 450 illustrated in FIG. 19B referred to later). The video information V_{A} can be interpreted to be video information indicating whether or not the input image 401 is an image obtained via the modifying process. Further, if the input image 401 is an image obtained by performing the modifying process one or more times (namely, if the input image 401 is the input image I[i] where i is one or larger), the video information V_{A} is changed in accordance with the number of times Q of performing the modifying process for obtaining the input image 401 (for example, see FIGS. 19A to 19C referred to later).

The number of times Q is the number of times of performing the modifying process performed on an image to be a base of the input image 401 for obtaining the input image 401. If the input image 401 is the input image I[i] where i is one or larger, the image to be a base of the input image 401 is the original image I[0]. If the input image 401 is the input image I[i], Q is i. Therefore, if the input image 401 is the original image I[0], Q is zero.

The display control portion 22 of FIG. 1 can know the number of times Q by reading data of number of modification times from the header region of the image file FL₄₀₁ corresponding to the input image 401, so as to generate video information V_{α} corresponding to the number of times Q and to display the same on the display portion 15.

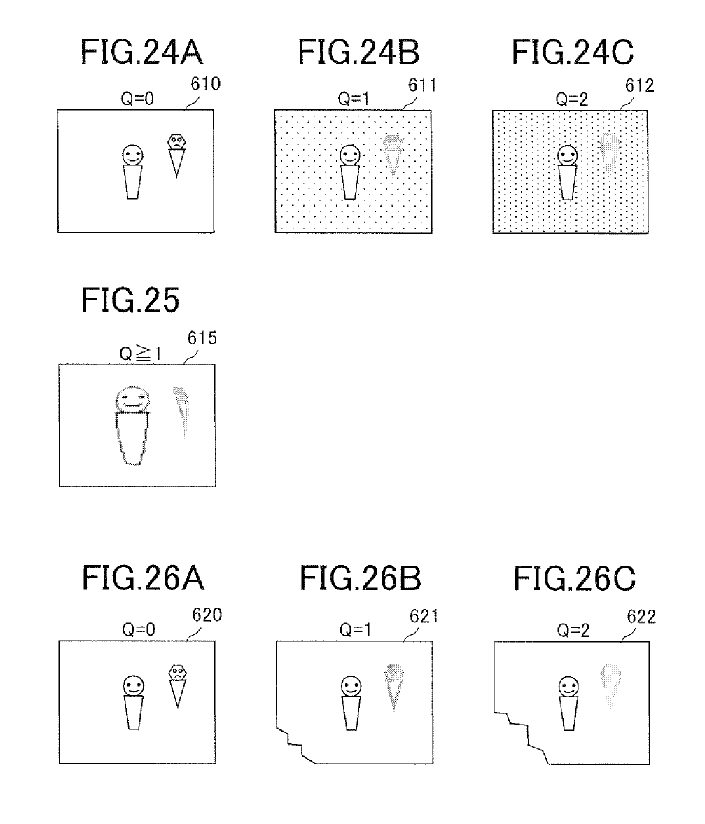

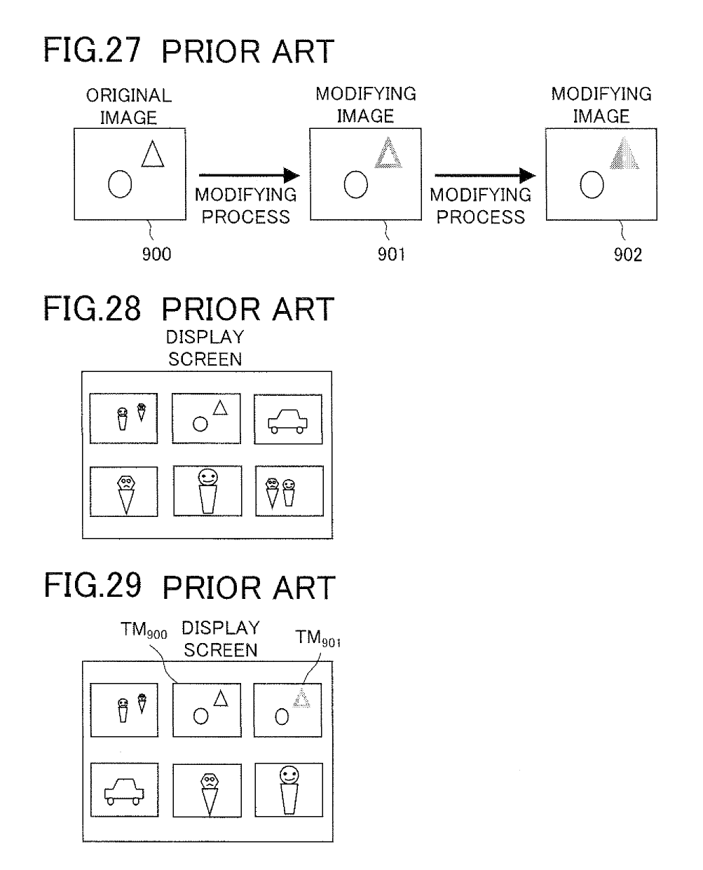

The display method β is described below. In the display method β, when the thumbnail image TM₄₀₁ is displayed, if the input image 401 is an image obtained via the modifying process, the thumbnail image TM₄₀₁ to be displayed is deformed (for example, see FIGS. 24A to 24C referred to later). It is needless to say that the deformation is based on the thumbnail image TM₄₀₁ that is displayed when the input image 401 is the original image. It can also be said that the display method β is a method of deforming the thumbnail image TM₄₀₁ to be displayed, in accordance with whether or not the input image 401 is an image obtained via the modifying process. Further, if the input image 401 is an image obtained by performing the modifying process one or more times (namely, if the input image 401 is the input image I[i] where i is one or larger), a deformed state of the thumbnail image TM₄₀₁ to be displayed is changed in accordance with the number of times Q of performing the modifying process for obtaining the input image 401 (for example, see FIGS. 24A to 24C referred to later). In other words, a deformed state of the thumbnail image TM₄₀₁ to be displayed is different between a case where Q is Q₁ and a case where Q is Q₂ (Q₁ and Q₂ are natural numbers, and Q₁ is not equal to Q₂).

The display control portion 22 of FIG. 1 can deform the thumbnail image TM₄₀₁ in accordance with the number of times Q and can display the thumbnail image TM₄₀₁ after the deformation on the display portion 15. The image processing for realizing the deformation of the thumbnail image TM₄₀₁ may be performed by the thumbnail generating portion 54 of FIG. 8.

Hereinafter, display method examples α₁ to α₅ that belong to the display method α and display method examples β₁ and β₂ that belong to the display method β are described individually. However, the display method examples α₁ to α₅, β₁, and β₂ are merely examples. As long as the user can recognize whether or not the input image 401 is the original image, or as long as the user can recognize the number of processing times Q performed on the input image 401, the video information V_{A} in the display method α can be any type of video information, and similarly, the deformation of the thumbnail image TM₄₀₁ in the display method β can be any type of deformation. Hereinafter, for convenience sake, the recognition whether or not the input image 401 is the original image by the user is referred to as process presence or absence recognition, and the recognition of the number of processing times Q performed on the input image 401 by the user is referred to as the number of processing times recognition.

### Display Method Example α₁

With reference to FIGS. 19A to 19C, the display method example α₁ is described below. Images 510, 511, and 512 are examples of images to be displayed in the display region DR[1] when Q is zero, one, or two, respectively (see also FIGS. 11A and 11B). The image 510 is the thumbnail image TM₄₀₁ itself, the image 511 is an image obtained by adding one icon 450 to the thumbnail image TM₄₀₁, and the image 512 is an image obtained by adding two icons 450 to the thumbnail image TM₄₀₁. The same is true when Q is three or larger, and the Q icons 450 can be displayed in a superimposing manner on the thumbnail image TM₄₀₁.

In other words, if Q is zero, the icon 450 is not displayed in the display region DR[1], but if Q is one or larger, the icons 450 in the number corresponding to a value of Q are displayed on the display region DR[1] together with the thumbnail image TM₄₀₁. The user can perform the process presence or absence recognition and the number of processing times recognition by viewing display presence or absence and the number of displays of the icon 450.

One or more icons 450 in the display method example α₁ are one type of the video information V_{A} (see FIG. 18). Regarding the Q icons 450 displayed on the thumbnail image TM₄₀₁ as one video information, the video information can be said to change in accordance with the number of times Q.

Note that if a plurality of icons 450 are displayed on the thumbnail image TM₄₀₁, the plurality of icons 450 may be different icons (for example, a blue icon 450 and a red icon 450 may be displayed on the thumbnail image TKO. In addition, it is possible to display the icon 450 not on the thumbnail image TM₄₀₁ but outside the display region of the thumbnail image TM₄₀₁ and in the vicinity of the display region of the thumbnail image TM₄₀₁. This can be applied to other icons than the icon 450 described later.

### Display Method Example α₂

With reference to FIGS. 20A to 20C, the display method example α₂ is described below. Images 520, 521, and 522 are examples of images to be displayed in the display region DR[1] when Q is zero, one, or two, respectively (see also FIGS. 11A and 11B). The image 520 is the thumbnail image TM₄₀₁ itself, and each of the images 521 and 522 is an image obtained by adding an icon 452 to the thumbnail image TM₄₀₁. However, as understood from FIGS. 20B and 20C, a display size of the icon 452 superimposed on the thumbnail image TM₄₀₁ is increased along with an increase of the number of times Q. The same is true in the case where Q is three or larger.

In other words, if Q is zero, the icon 452 is not displayed in the display region DR[1], but if Q is one or larger, the icon 452 is displayed on the display region DR[1] in a display size corresponding to a value of Q together with the thumbnail image TM₄₀₁. The user can perform the process presence or absence recognition and the number of processing times recognition by viewing display presence or absence and the display size of the icon 452.

The icon 452 in the display method example α₂ is one type of the video information V_{A} (see FIG. 18). The icon 452 as the video information has a variation in accordance with the number of times Q (display size variation).

### Display Method Example α₃

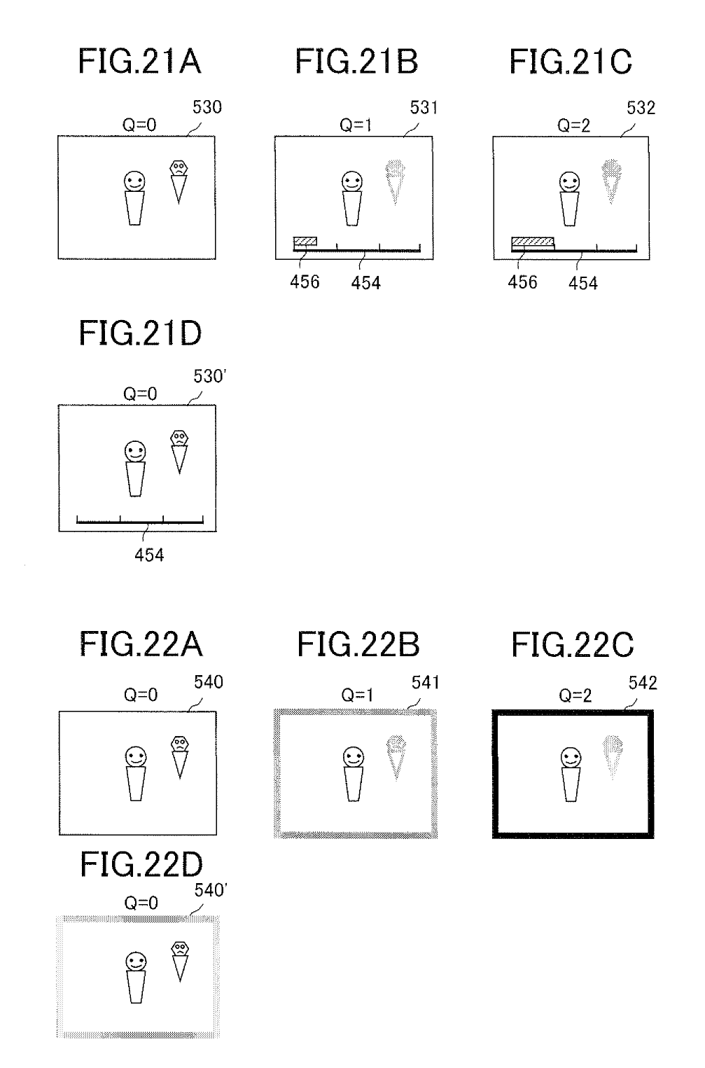

With reference to FIGS. 21A to 21D, the display method example α₃ is described below. Images 530, 531, and 532 are examples of images to be displayed in the display region DR[1] when Q is zero, one, or two, respectively (see also FIGS. 11A and 11B). The image 530 is the thumbnail image TM₄₀₁ itself; and each of the images 531 and 532 is an image obtained by adding a gage icon 454 and a bar icon 456 to the thumbnail image TM₄₀₁. However, as understood from FIGS. 21B and 21C, a display size of the bar icon 456 superimposed on the thumbnail image TM₄₀₁ is set larger in the longitudinal direction of the gage icon 454 as the number of times Q becomes larger. The same is true in the case where Q is three or larger.

In other words, if Q is zero, the icons 454 and 456 are not displayed in the display region DR[1], but if Q is one or larger, the bar icon 456 having a length corresponding to the value of Q is displayed in the display region DR[1] together with the thumbnail image TM₄₀₁. The user can perform the process presence or absence recognition and the number of processing times recognition by viewing display presence or absence of the icons 454 and 456 and the length of the bar icon 456.

The icons 454 and 456 in the display method example α₃ are one type of the video information V_{A} (see FIG. 18). The bar icon 456 as the video information has a variation in accordance with the number of times Q (a display size variation or a display length variation).

Note that if Q is zero, an image 530′ of FIG. 21D may be displayed instead of the image 530 of FIG. 21A in the display region DR[1]. The image 530′ is an image obtained by adding only the gage icon 454 to the thumbnail image TM₄₀₁. In this case too, the bar icon 456 that is displayed when Q is one or larger is one type of the video information V_{A}. In addition, the icon 450 illustrated in FIG. 19A and the like may be displayed together with the thumbnail image TM₄₀₁ in the display region DR[1] only when Q is one or larger.

### Display Method Example α₄

With reference to FIGS. 22A to 22D, the display method example α₄ is described below. Images 540, 541, and 542 are examples of images to be displayed in the display region DR[1] when Q is zero, one, or two, respectively (see also FIGS. 11A and 11B). The image 540 is the thumbnail image TM₄₀₁ itself, and each of the images 541 and 542 is an image obtained by adding a frame icon surrounding a periphery of the thumbnail image TM₄₀₁ to the thumbnail image TM₄₀₁. However, as understood from FIGS. 22B and 22C, a color of the frame icon added to the thumbnail image TM₄₀₁ when Q is one or larger varies in accordance with the number of times Q. The same is true in the case where Q is three or larger.

In other words, if Q is zero, the frame icon is not displayed in the display region DR[1], but if Q is one or larger, the frame icon having a color corresponding to the value of Q is displayed in the display region DR[1] together with the thumbnail image TM₄₀₁. The user can perform the process presence or absence recognition and the number of processing times recognition by viewing display presence or absence of the frame icon and the color of the frame icon.

The frame icon in the display method example α₄ is one type of the video information V_{A} (see FIG. 18). The frame icon as the video information has a variation in accordance with the number of times Q (color variation).

Note that if Q is zero, an image 540′ of FIG. 22D may be displayed instead of the image 540 of FIG. 22A in the display region DR[1]. The image 540′ is also an image obtained by adding the frame icon surrounding a periphery of the thumbnail image TM₄₀₁ to the thumbnail image TM₄₀₁ similarly to the images 541 and 542. However, the color of the frame icon in the image 540′, namely the color of the frame icon displayed when Q is zero is different from the color of the frame icon displayed when Q is one or larger. The color of the frame icon displayed when Q is zero, one, or two is referred to as a first color, a second color, or a third color. Then, the frame icon having the second or third color is the video information V_{A} indicating that the input image 401 is an image obtained via the modifying process, but the frame icon having the first color is not such the video information V_{A} (first, second, and third colors are different from one another).

However, it is possible to interpret that the video information indicating whether or not the input image 401 is an image obtained via the modifying process is the video information V_{A}. According to this interpretation, in the example of the images 540′, 541, and 542, the frame icon in each of the images 540′, 541, and 542 can be regarded as the video information V_{A}, and the color of the frame icon indicates whether or not the input image 401 is an image obtained via the modifying process.

### Display Method Example α₅

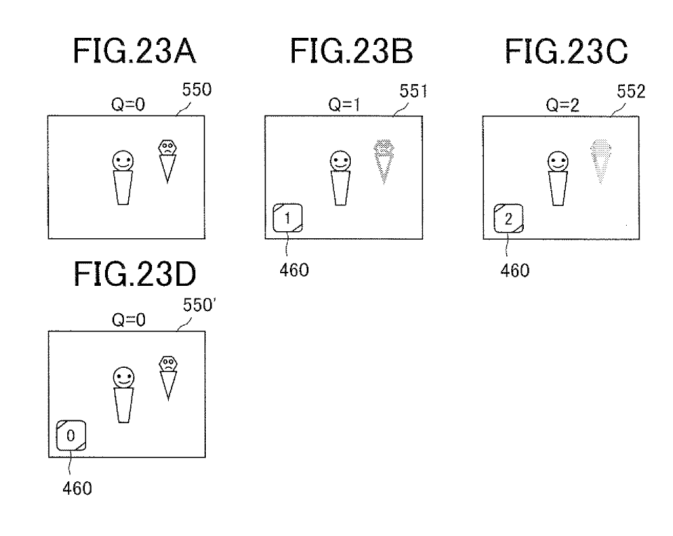

With reference to FIGS. 23A to 23D, the display method example α₅ is described below. Images 550, 551, and 552 are examples of images to be displayed in the display region DR[1] when Q is zero, one, or two, respectively (see also FIGS. 11A and 11B). The image 550 is the thumbnail image TM₄₀₁ itself, and each of the images 551 and 552 is an image obtained by adding an icon 460 constituted of a numeric value and a figure to the thumbnail image TM₄₀₁ (the icon 460 may be constituted of only a numeric value). However, as understood from FIGS. 23B and 23C, a numeric value in the icon 460 added to the thumbnail image TM₄₀₁ when Q is one or larger varies in accordance with the number of times Q. The same is true in the case where Q is three or larger.

In other words, if Q is zero, the icon 460 is not displayed in the display region DR[1], but if Q is one or larger, the icon 460 including the numeric value corresponding to the value of Q (simply the value of Q itself) as a character is displayed in the display region DR[1] together with the thumbnail image TM₄₀₁. The user can perform the process presence or absence recognition and the number of processing times recognition by viewing display presence or absence of the icon 460 and the numeric value in the icon 460.

The icon 460 in the display method example α₅ is one type of the video information V_{A} (see FIG. 18). The icon 460 as the video information has a variation in accordance with the number of times Q (variation of the numeric value in the icon 460).

Note that if Q is zero, an image 550′ of FIG. 23D may be displayed instead of the image 550 of FIG. 23A in the display region DR[1]. The image 550′ is also an image obtained by adding the icon 460 to the thumbnail image TM₄₀₁ similarly to the images 551 and 552. However, the numeric value in the icon 460 of the image 550′, namely the numeric value in the icon 460 displayed when Q is zero is different from the numeric value in the icon 460 displayed when Q is one or larger. In this case, the icon 460 in the image 551 or 552 is the video information V_{A} indicating that the input image 401 is an image obtained via the modifying process, but the icon 460 in the image 550′ is not such the video information V_{A}.

However, it is possible to interpret that the video information indicating whether or not the input image 401 is an image obtained via the modifying process is the video information V_{A}. According to this interpretation, in the example of the images 550′, 551, and 552, the icon 460 in each of the images 550′, 551, and 552 can be regarded as the video information V_{A}, and the numeric value in the icon 460 indicates whether or not the input image 401 is an image obtained via the modifying process.

### Display Method Example β₁

With reference to FIGS. 24A to 24C, the display method example β₁ is described below. Images 610, 611, and 612 are examples of images to be displayed in the display region DR[1] when Q is zero, one, or two, respectively (see also FIGS. 11A and 11B). The image 610 is the thumbnail image TM₄₀₁ itself, and each of the images 611 and 612 is an image obtained by performing image processing J_{β1} for deforming the thumbnail image TM₄₀₁ on the thumbnail image TM₄₀₁. However, FIGS. 24B and 24C, process content of the image processing J_{β1} performed on the thumbnail image TM₄₀₁ when Q is one or larger varies in accordance with the number of times Q (namely, a deformed state of the thumbnail image TM₄₀₁ to be displayed varies in accordance with the number of times Q). The same is true in the case where Q is three or larger.

For instance, the image processing J_{β1} may be a filtering process using a spatial domain filter or a frequency domain filter. More specifically, for example, the image processing J_{β1} may be a smoothing process for smoothing the thumbnail image TM₄₀₁. In this case, a degree of smoothing can be varied in accordance with the number of times Q (for example, filter intensity of the smoothing filter for performing the smoothing is increased along with an increase of the number of times Q). Alternatively, for example, the image processing J_{β1} may be image processing of reducing luminance, chroma, or contrast of the thumbnail image TM₄₀₁. In this case, a degree of reducing luminance, chroma, or contrast can be varied in accordance with the number of times Q (for example, the degree of reducing can be increased along with an increase of the number of times Q). The user can perform the process presence or absence recognition and the number of processing times recognition by viewing the display content of the display region DR[1].

In addition, for example, the image processing J_{β1} may be a geometric conversion. The geometric conversion as the image processing J_{β1} may be a fish-eye conversion process for converting the thumbnail image TM₄₀₁ into a fish-eye image obtained as if using a fish-eye lens. An image 615 of FIG. 25 is an example of the fish-eye image that can be displayed in the display region DR[1] when Q is one or larger. Also in the case where the geometric conversion is used as the image processing J_{β1}, the thumbnail image TM₄₀₁ to be displayed on the display region DR[1] is deformed, and the degree of the deformation is varied in accordance with the number of times Q.

### Display Method Example β₂

With reference to FIGS. 26A to 26C, the display method example β₂ is described below. Images 620, 621, and 622 are examples of images to be displayed in the display region DR[1] when Q is zero, one, or two, respectively (see also FIGS. 11A and 11B). The image 620 is the thumbnail image TM₄₀₁ itself, and each of the images 621 and 622 is an image obtained by the image processing J_{β2} for deforming the thumbnail image TM₄₀₁ on the thumbnail image TM₄₀₁.

The image processing J_{β2} is image processing for cutting a part of the thumbnail image TM₄₀₁, and the cutting amount varies in accordance with the number of times Q. In the image processing J_{β2}, the entire image region of the thumbnail image TM₄₀₁ is split into first and second image regions, and the second image region of the thumbnail image TM₄₀₁ is removed from the thumbnail image TM₄₀₁. In other words, the image in the first image region of the thumbnail image TM₄₀₁ is the image 621 or 622. A size or a shape of the second image region to be removed varies in accordance with the number of times Q (namely, a deformed state of the thumbnail image TM₄₀₁ to be displayed varies in accordance with the number of times Q). For instance, as illustrated in FIGS. 26B and 26C, a size of the second image region can be increased along with an increase of the number of times Q. The same is true in the case where Q is three or larger. The user can perform the process presence or absence recognition and the number of processing times recognition by viewing display content of the display region DR[1].

### Second Embodiment

A second embodiment of the present invention is described below. The second embodiment is an embodiment based on the first embodiment. Unless otherwise noted in the second embodiment, the description of the first embodiment is applied to the second embodiment, too, as long as no contradiction arises. The elements included in the image pickup apparatus 1 of the first embodiment are also included in the image pickup apparatus 1 of the second embodiment.

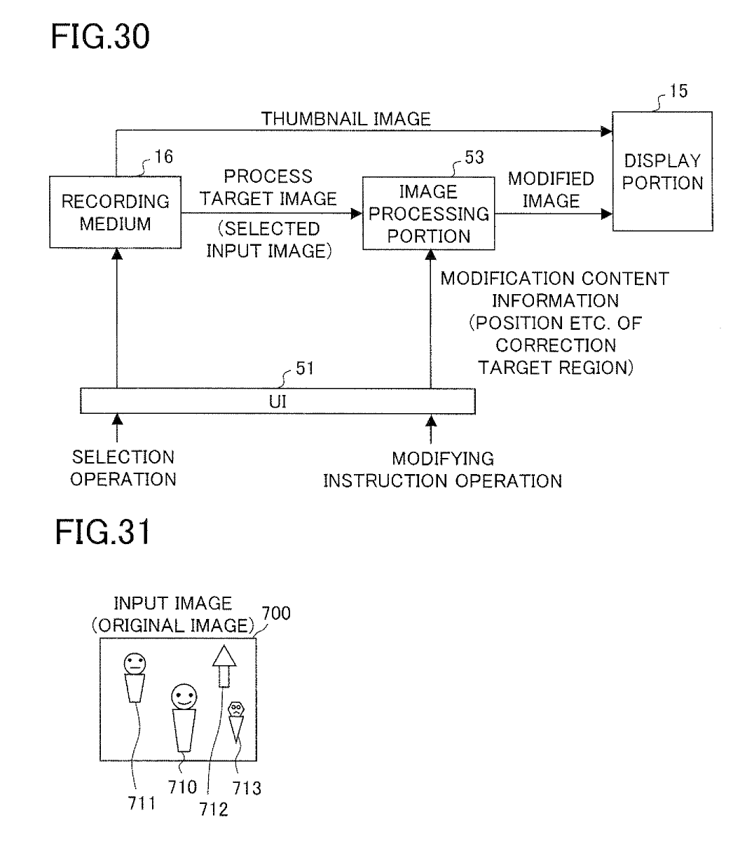

FIG. 30 is a block diagram of a portion particularly related to a characteristic action of the second embodiment. As described above, the UI 51 accepts user's various operations including the selection operation for selecting the process target image and the modifying instruction operation for instructing to perform the modifying process on the process target image, and the modification content information is designated by the modifying instruction operation. In the second embodiment, it is supposed that a position, a size, a shape, and the like of the correction target region are designated by the modification content information, and that the image processing portion 53 performs image processing P for correcting the correction target region within the process target image using the modification content information. The process target image after the correction of the correction target region by the image processing P is output as the modified image from the image processing portion 53. The correction target region is a part of the entire image region of the input image.

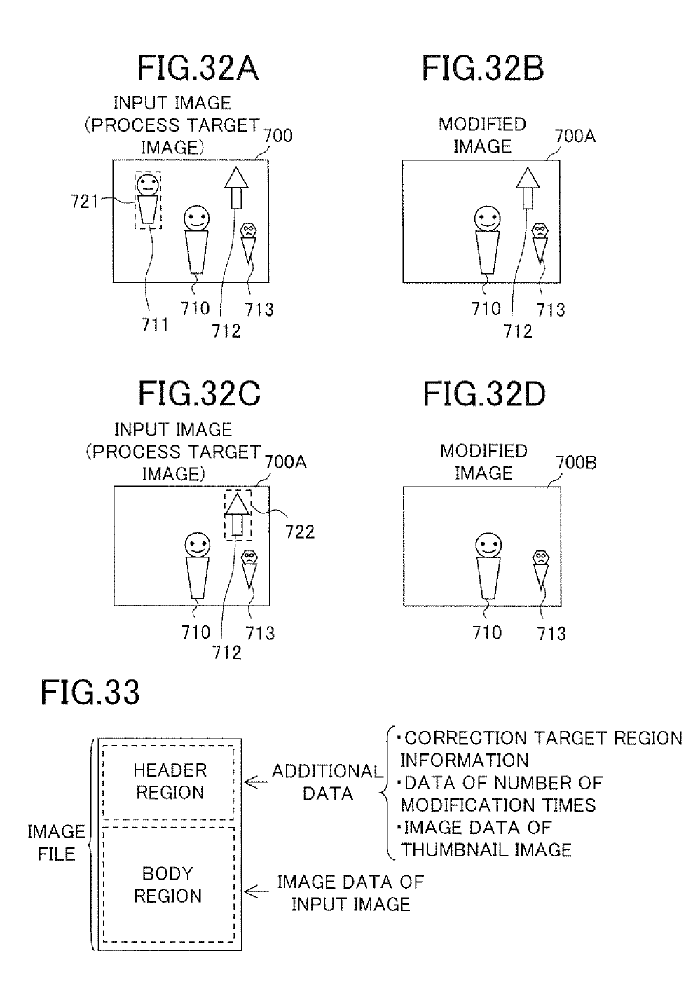

The image processing P is described below. An input image 700 of FIG. 31 is an example of the original image (namely, the input image I[0]) (see FIG. 6). In the input image 700, there are image data of four subjects 710 to 713. It is supposed that the user regards the subject 711 as unnecessary object (unnecessary subject) and wants to remove the subject 711 from the input image 700. In this case, the user designates the subject 711 as an unnecessary object by the modifying instruction operation in a state where the input image 700 is selected as the process target image by the selection operation. Thus, a position, a size, and a shape of an image region 721 in which the image data of the subject 711 exists in the input image 700 are determined (see FIG. 32A). The user may designate all the details of a position, a size, and a shape of the image region 721 by the modifying instruction operation using the UI 51, or may determine the details thereof based on the modifying instruction operation using a contour extraction process or the like by the image processing portion 53.

The image processing portion 53 sets the image region 721 as the correction target region and performs the image processing P for removing the subject 711 from the input image 700 (namely, the image processing P for correcting the correction target region). For instance, the image processing portion 53 removes the subject 711 as the unnecessary object from the input image 700 using image data of a region for correction as an image region different from the correction target region, and generates an image after this removal as a modified image 700A (see FIG. 32B). The region for correction is usually an image region in the process target image (input image 700) but may be an image region in other image than the process target image. As the method of the image processing P for removing the unnecessary object including a method of setting the region for correction, a known method (for example, a method described in JP-A-2011-170838 or JP-A-2011-170840) can be used. For instance, it is possible to replace the image data of the correction target region with image data of the region for correction so as to remove the unnecessary object. Alternatively, it is possible to mix the image data of the region for correction to the image data of the correction target region so as to remove the unnecessary object. Note that the removal may be complete removal or may be partial removal. In addition, for convenience sake of illustration, the correction target region 721 has a rectangular shape in the example of FIG. 32A, but it is possible to adopt other shape than the rectangular shape (such as a shape along a contour of the unnecessary object) (the same is true for other correction target region described later).

The user can also select the modified image 700A that is an example of the input image I[1] (see FIG. 6) as a new process target image and designate the subject 712 as another unnecessary object by the modifying instruction operation. In FIG. 32C, an image region 722 where image data of the subject 712 exists is a new correction target region set by the process target image 700A via this designation. When this designation is performed, the image processing portion 53 performs the image processing P on the process target image 700A and generates a modified image 700E that is an image obtained by removing the subject 712 from the process target image 700A (see FIG. 32D). Similarly, it is possible to further perform the image processing P for removing the subject 713 from the modified image 700B.

The method of recording the image data of the modified image and the additional data (see also FIG. 4) described above with reference to FIG. 8 is also applied to this embodiment. However, in the second embodiment, as illustrated in FIG. 33, the additional data stored in the image file includes the data of number of modification times, the image data of the thumbnail image, and further includes the correction target region information. In other words, when the modifying process (image processing P) is performed on the input image I[i] one time so that the input image I[1+1] is generated, not only the image data of the input image I[i+1], the image data of the thumbnail image TM[i+1], and the data of number of modification times, but also the correction target region information is recorded in the image file FL[i+1].

The correction target region information record in the image file FL[i+1] specifies a position, a size, and a shape of the correction target region set in the input image I[i] for obtaining the input image I[i+1] from the input image I[i]. For instance, the correction target region information recorded in the image file of the input image 700A specifies a position, a size, and a shape of the correction target region 721 set in the input image 700 for obtaining the input image 700A from the input image 700. If the input image I[i+1] is obtained by performing the image processing P two or more times, the correction target region information of each image processing P is recorded in the image file FL[i+1]. In other words, for example, the image file of the input image 700B stores the correction target region information specifying a position, a size, and a shape of the correction target region 721 set in the input image 700 for obtaining the input image 700A from the input image 700, and the correction target region information specifying a position, a size, and a shape of the correction target region 722 set in the input image 700A for obtaining the input image 700B from the input image 700A. A position, a size, and a shape of the correction target region 721 may be considered to be a position, a size, and a shape of the subject 711 (the same is true for the correction target region 722 and the like).

A flowchart of an action of generating the modified image is the same as that of FIG. 9. However, if the modifying process is the image processing P, the process of Steps S13 and S14 is eliminated.

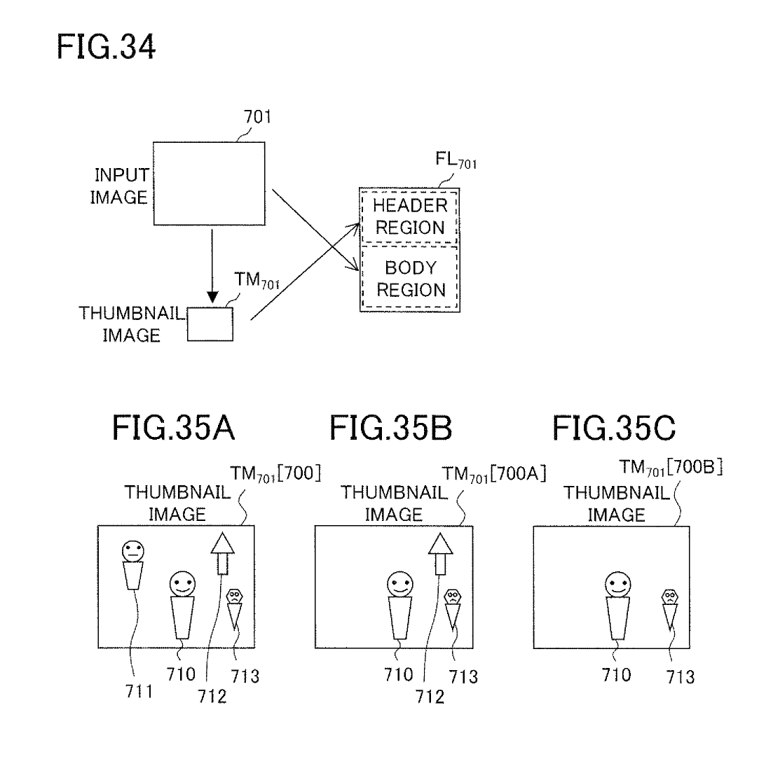

Next, an action of the image pickup apparatus 1 in the thumbnail display mode is described below. It is supposed that the image data of a plurality of input images including an input image 701 of FIG. 34 and the input images 402 to 406 of FIG. 10 are recorded in the recording medium 16 (in FIG. 34, subjects in the images are not shown for convenience sake). As illustrated in FIG. 34, a thumbnail image of the input image 701 is denoted by symbol TM₇₀₁, and an image file storing image data of the input image 701 and the thumbnail image TM₇₀₁ is denoted by symbol FL₇₀₁. Then, the entire description of the action of the thumbnail display mode in the first embodiment can be applied to the second embodiment by reading the input image 401, the thumbnail image TM₄₀₁, the image file FL₄₀₁, and the image processing J in the first embodiment as the input image 701, the thumbnail image TM₇₀₁, the image file FL₇₀₁, and the image processing P, respectively. This application includes the above-mentioned special display function as a matter of course, and also includes the display method a containing the display method examples α₁ to α₅ and the display method β containing the display method examples β₁ and β₂. As described above in the first embodiment, when the thumbnail image TM₇₀₁ is displayed for example, by the display portion 15 with the special display function, the display portion 15 displays visually whether or not the input image 701 corresponding to the thumbnail image TM₇₀₁ is an image obtained via the modifying process.

With reference to the state where the thumbnail images TM₇₀₁, and TM₄₀₂ to TM₄₀₆ are simultaneously displayed in the display regions DR[1], and DR[2] to DR[6] of the display screen illustrated in FIG. 11A, respectively, there are described some examples of a method for realizing the special display function. It is supposed that the input image 701 is any one of the input images 700, 700A, and 700B (see FIGS. 32A to 32D). Therefore, the thumbnail image TM₇₀₁ is a thumbnail image based on any one of the input images 700, 700A, and 700B. For convenience sake of description, the thumbnail image TM₇₀₁ based on the input images 700, 700A, or 700B is particularly denoted by symbols TM₇₀₁[700], TM₇₀₁ [700A], and TM₇₀₁[700B], respectively (see FIGS. 35A to 35C). The symbol Q denotes the number of times of performing the modifying process (image processing P) for obtaining the input image 701. If the input image 701 is the input image 700, Q is zero. If the input image 701 is the input image 700A, Q is one. If the input image 701 is the input image 700B, Q is two.

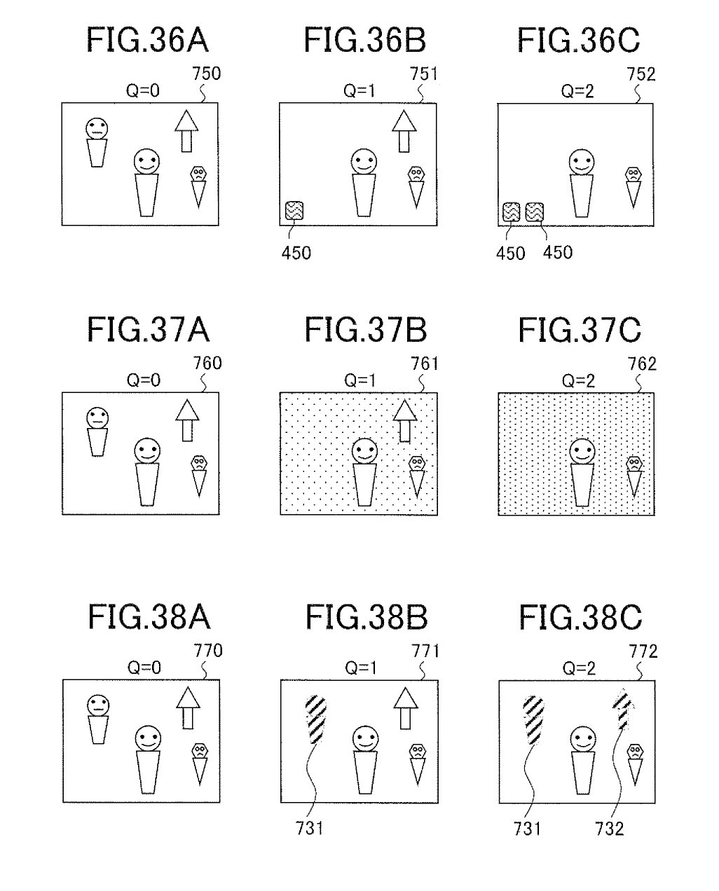

FIGS. 36A to 36C illustrate an example in which the display method example α₁ corresponding to FIGS. 19A to 19C is applied to the second embodiment. Images 750, 751, and 752 are examples of thumbnail images to be displayed in the display region DR[1] when Q is zero, one, or two, respectively. The image 750 is the thumbnail image TM₇₀₁[700] itself based on the input image 700, the image 751 is an image obtained by adding only one icon 450 to the thumbnail image TM₇₀₁[700A] based on the input image 700A, and the image 752 is an image obtained by adding two icons 450 to the thumbnail image TM₇₀₁[700B] based on the input image 700B. The same is true when Q is three or larger, and the Q icons 450 can be displayed in a superimposing manner on the thumbnail image TM₇₀₁.

FIGS. 37A to 37C illustrate an example in which the display method example β₁ corresponding to FIGS. 24A to 24C is applied to the second embodiment. Images 760, 761, and 762 are examples of thumbnail images to be displayed in the display region DR[1] when Q is zero, one, or two, respectively. The image 760 is the thumbnail image TM₇₀₁[700] itself based on the input image 700. The images 761 and 762 are images obtained by performing the above-mentioned image processing J_{β1} on the thumbnail image TM₇₀₁[700A] based on the input image 700A and the thumbnail image TM₇₀₁[700B] based on the input image 700B, respectively. As described above in the first embodiment, process content of the image processing J_{β1} varies in accordance with the number of times Q (namely, a deformed state of the thumbnail image TM₇₀₁ to be displayed varies in accordance with the number of times Q). The same is true in the case where Q is three or larger.

In addition, it is possible to perform the display as illustrated in FIGS. 38A to 38C. Images 770, 771, and 772 are examples of thumbnail images to be displayed in the display region DR[1] when Q is zero, one, or two, respectively. The image 770 is the thumbnail image TM₇₀₁[700] itself based on the input image 700. The image 771 is an image obtained by adding a hatching marker 731 to the thumbnail image TM₇₀₁[700A] based on the input image 700A. The image 772 is an image obtained by adding hatching markers 731 and 732 to the thumbnail image TM₇₀₁ [700B] based on the input image 700B.

The display control portion 22 or the thumbnail generating portion 54 (see FIG. 1 or 8) determines positions, sizes, and shapes of the hatching markers 731 and 732 based on the correction target region information read out from the image file FL₇₀₁. Specifically, for example, the display control portion 22 or the thumbnail generating portion 54 adds the hatching marker 731 to a position on the thumbnail image TM₇₀₁[700A] corresponding to the position of the correction target region 721 on the input image 700 (original image) (see FIGS. 32A and 35B), and hence generats the image 771 of FIG. 38B. Similarly, for example, the display control portion 22 or the thumbnail generating portion 54 adds the hatching markers 731 and 732 to positions on the thumbnail image TM₇₀₁[700B] corresponding to the positions of the correction target regions 721 and 722 on the input image 700 or 700A (see FIGS. 32A and 35C), and hence generates the image 772 of FIG. 38C. A size and a shape of the hatching marker 731 correspond to those of the subject 711 (namely, a size and a shape of the correction target region 721 of FIG. 32A). The same is true for the hatching marker 732.

Viewing the hatching marker, the user can easily recognize that the input image corresponding to the image 771 or 772 of FIG. 38B or 38C is an image obtained via the image processing P. Further, the thumbnail image display including the hatching marker enables the user to specify and recognize a position, a size, and a shape of the correction target region on the displayed thumbnail image. The hatching marker can be considered to be one type of the video information V_{A}. The display method illustrated in FIGS. 38A to 38C and the display method illustrated in FIGS. 36A to 36C may be combined and performed. In other words, both the icon 450 and the hatching marker may be added to the thumbnail image corresponding to the modified image, so that the thumbnail image after the addition can be displayed.

(Variations)

The embodiment of the present invention can be modified appropriately and variously in the scope of the technical concept described in the claims. The embodiment described above is merely an example of the embodiment of the present invention, and the present invention and the meanings of terms of the elements are not limited to those described in the embodiment. Specific numerical values exemplified in the above description are merely examples, which can be changed to various values as a matter of course. As annotations that can be applied to the embodiment described above, Notes 1 to 4 are described below. The descriptions in the Notes can be combined arbitrarily as long as no contradiction arises.

[Note 1]

In the above-mentioned first and second embodiments, it is mainly supposed that the modifying process for obtaining the modified image from the process target image is the image processing J for adjusting the focused state or the image processing P for correcting a specific image region. However, the modifying process may be any type of image processing as long as it is an image processing for modifying the process target image. For instance, the modifying process may include an arbitrary image processing such as geometric conversion, resolution conversion, gradation conversion, color correction, or filtering.

[Note 2]

In each embodiment described above, it is supposed that the input image is an image obtained by photography with the image pickup apparatus 1. However, the input image may not be an image obtained by photography with the image pickup apparatus 1. For instance, the input image may be an image taken by an image pickup apparatus (not shown) other than the image pickup apparatus 1 or an image supplied from an arbitrary recording medium to the image pickup apparatus 1, or an image supplied to the image pickup apparatus 1 via a communication network such as the Internet.

[Note 3]

The portion related to realization of the above-mentioned special display function (particularly, for example, the UI 51, the main control portion 13 including the display control portion 22, the distance map generating portion 52, the image processing portion 53, and the thumbnail generating portion 54, the display portion 15, and the recording medium 16) may be disposed in electronic equipment (not shown) other than the image pickup apparatus 1 so that the individual actions can be realized on the electronic equipment. The electronic equipment is, for example, a personal computer, a mobile information terminal, or a mobile phone. Note that the image pickup apparatus 1 is also one type of the electronic equipment.

[Note 4]

The image pickup apparatus 1 and the electronic equipment may be constituted of hardware or a combination of hardware and software. If the image pickup apparatus 1 or the electronic equipment is constituted using software, the block diagram of a portion realized by software indicates a functional block diagram of the portion. The function realized using software may be described as a program, and the program may be executed by a program executing device (for example, a computer) so that the function can be realized.

What is claimed is:

1. An electronic equipment comprising:
a display portion that displays a thumbnail image of an input image;
a user interface that receives a modifying instruction operation for instructing to perform a modifying process; and
an image processing portion that performs the modifying process on the input image or an image to be a base of the input image in accordance with the modifying instruction operation, wherein
when the thumbnail image is displayed on the display portion, it is visually indicated using the display portion whether or not the input image is an image obtained via the modifying process.

2. The electronic equipment according to claim 1, wherein when the thumbnail image is displayed on the display portion, if the input image is the image obtained via the modifying process, video information indicating that the input image is the image obtained via the modifying process is also displayed.

3. The electronic equipment according to claim 2, wherein if the input image is the image obtained via the modifying process, the video information is changed in accordance with the number of times of the modifying process performed for obtaining the input image.

4. The electronic equipment according to claim 1, wherein when the thumbnail image is displayed on the display portion, if the input image is the image obtained via the modifying process, the displayed thumbnail image is deformed.

5. The electronic equipment according to claim 4, wherein if the input image is the image obtained via the modifying process, a deformed state of the displayed thumbnail image is changed in accordance with the number of times of the modifying process performed for obtaining the input image.

6. The electronic equipment according to claim 1, wherein the modifying process includes image processing for changing a focused state of the input image or the image to be the base of the input image.

7. The electronic equipment according to claim 1, wherein the modifying process includes image processing for correcting a correction target region set in the input image or the image to be the base of the input image, using image data of other image region.

8. The electronic equipment according to claim 2, wherein the modifying process includes image processing for correcting a correction target region set in the input image or the image to be the base of the input image, using image data of other image region, and
if the input image is the image obtained via the modifying process, the video information is displayed so that a position of the correction target region can be specified on the thumbnail image.
